(19) United States
(12) Patent Application Publication
(10) Pub. No.: US 2026/0203952 A1
(43) Pub. Date: Jul. 16, 2026

(54) METHOD FOR ENCODING/ DECODING DYNAMIC MESH AND RECORDING MEDIUM STORING THE METHOD FOR ENCODING DYNAMIC MESH

(71) Applicant: Electronics and Telecommunications Research Institute, Daejeon (KR)

(72) Inventors: Da Yun NAM, Daejeon (KR); Seong Yong LIM, Daejeon (KR)

(73) Assignee: Electronics and Telecommunications Research Institute, Daejeon (KR)

(21) Appl. No.: 19/449,618

(22) Filed: Jan. 15, 2026

(30) Foreign Application Priority Data
Jan. 15, 2025 (KR) 10-2025-0006366
Mar. 24, 2025 (KR) 10-2025-0037599

(51) Int. Cl. G06T 9/00; G06T 7/12

(52) U.S. Cl. CPC G06T 9/001; G06T 7/12

(57) ABSTRACT

A method of encoding a dynamic mesh according to the present disclosure may comprise obtaining a base mesh from an input mesh; generating a subdivided mesh by subdividing the base mesh; generating displacement information based on the subdivided mesh; and encoding the base mesh and the displacement information, wherein the method further comprises determining whether adaptive edge segmentation is applied to at least one of subdivision iterations.

### BACKGROUND OF THE INVENTION

### Field of the Invention

The present disclosure relates to a method of encoding/decoding a dynamic mesh.

### Description of the Related Art

Static or dynamic 2D data may generally be encoded/decoded using image or video compression codecs such as AVC, HEVC or VVC. Due to high compression performance of the compression codecs, a method of using the compression codecs to compress immersive video or mesh has continuously been studied.

### SUMMARY OF THE INVENTION

It is an object of the present disclosure to provide a method of subdividing a mesh using adaptive mesh segmentation.

It is a further object of the present disclosure to provide a method of determining whether to apply adaptive mesh segmentation in units of coding units of subdivision iterations.

It is a further object of the present disclosure to provide a method of performing adaptive mesh segmentation based on the characteristics of faces, edges, or vertices.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of encoding a dynamic mesh, the method comprising obtaining a base mesh from an input mesh; generating a subdivided mesh by subdividing the base mesh; generating displacement information based on the subdivided mesh; and encoding the base mesh and the displacement information, wherein the method further comprises determining whether adaptive edge segmentation is applied to at least one of subdivision iterations.

In the method of encoding the dynamic mesh according to the present disclosure, in response to the adaptive edge segmentation being applied, whether to subdivide an edge is determined by comparing a length of the edge with a threshold value.

In the method of encoding the dynamic mesh according to the present disclosure, in response to the edge being subdivided, a number of newly generated vertices subdividing the edge is greater than or equal to 1.

In the method of encoding the dynamic mesh according to the present disclosure, the threshold value is determined in a unit of sub-mesh.

In the method of encoding the dynamic mesh according to the present disclosure, the threshold value is determined in a unit of subdivision iteration.

In the method of encoding the dynamic mesh according to the present disclosure, the threshold value is adaptively determined based on at least one of a ratio of vertex, a ratio of face, a number of vertices, or a number of faces.

In the method of encoding the dynamic mesh according to the present disclosure, the threshold value is adaptively determined based on a statice of edge lengths.

In the method of encoding the dynamic mesh according to the present disclosure, the adaptive edge segmentation is enabled not only when a subdivision method is a midpoint subdivision, but also when the subdivision method is a loop subdivision, a normal subdivision, or Pythag subdivision.

In the method of encoding the dynamic mesh according to the present disclosure, in response to the adaptive edge segmentation being applied, face information and edge information are updated based on position information updated based on a pre-defined subdivision method.

In the method of encoding the dynamic mesh according to the present disclosure, the pre-defined subdivision method is the midpoint subdivision.

In the method of encoding the dynamic mesh according to the present disclosure, in response to the adaptive edge segmentation being applied, face information and edge information are updated based on position information updated based on a subdivision method determined by signaled information.

In the method of encoding the dynamic mesh according to the present disclosure, the subdivision method determined by the signaled information is one of the midpoint subdivision, the loop subdivision, the normal subdivision, or the Pythag subdivision.

In the method of encoding the dynamic mesh according to the present disclosure, whether the adaptive edge segmentation is applied or not is determined for each of subdivision iteration.

In the method of encoding the dynamic mesh according to the present disclosure, in response to the adaptive edge segmentation being applied, a segmentation depth is determined in a unit of edge.

In the method of encoding the dynamic mesh according to the present disclosure, in response to the adaptive edge segmentation being applied, at least one of a segmentation tree type or a segmentation depth is determined in a unit of face.

In the method of encoding the dynamic mesh according to the present disclosure, in response to the adaptive edge segmentation being applied, one of segmentation structures is selected according to a shape of a face.

In the method of encoding the dynamic mesh according to the present disclosure, even though the adaptive edge segmentation is applied, subdivision on a face, an edge or a vertex that is determined as an outlier is performed without comparing the length of the edge with the threshold value.

To accomplish the above and other objects, the present disclosure also provides a method of decoding a dynamic mesh which comprising: decoding a base mesh; generating a subdivided mesh by subdividing the base mesh; and reconstructing a mesh based on the subdivided mesh and decoded displacement information, wherein the method further comprises determining whether adaptive edge segmentation is applied to at least one of subdivision iterations.

Meanwhile, in the present disclosure, it is possible to provide a computer-readable recording medium recording instructions for implementing the method of encoding/decoding the dynamic mesh.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of an encoder for encoding a dynamic mesh;

FIG. 2 is a block diagram of a decoder for decoding the dynamic mesh;

FIG. 3 is a flowchart of the process of subdividing a base mesh.

FIG. 4 is a flowchart illustrating the process of performing subdivision.

FIG. 5 illustrates cases where the number of newly generated vertices is 1 and 2 through edge segmentation.

FIG. 6 illustrates an example in which the partitioning structure is determined differently depending on the face shape.

### DETAILED DESCRIPTION OF THE INVENTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. For example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. For example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being "connected" or "linked" to another element, it should be understood that the element may be directly connected or linked to that another element, but there may be another element therebetween. Meanwhile, when an element is referred to as being "directly connected" or "directly linked" to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as "include" or "have", etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of "including" a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

Dynamic mesh refers to mesh content whose geometry, attribute, and connectivity information change over time. The dynamic mesh may be separated into geometry information and attribute information. That is, the encoding and decoding of a dynamic mesh may involve encoding and decoding the geometry information and the attribute information independently.

The geometry information may include vertices constituting the dynamic mesh, the connectivity between vertices, and information regarding faces, where each face may be a triangular shape formed by three vertices. The geometry information may represent the positions of vertices in three-dimensional space. Through preprocessing, the geometry information may be further divided into a base mesh and displacement information.

The base mesh may be obtained by applying at least one of mesh decimation or geometry parameterization to the original mesh. The base mesh may be encoded and decoded using a static mesh codec, such as Draco or TFAN.

The displacement information may represent the difference between a fitted mesh generated through subdivision surface fitting and a subdivided base mesh. The displacement information may be encoded and decoded using a conventional video codec, such as HEVC, VVC, or AV1, or using an arithmetic codec.

The attribute information may include an attribute map or a texture map. Through a texture transfer process, the attribute map may be updated or regenerated. The texture transfer may involve re-parameterizing the attribute map of the original mesh to correspond to the reconstructed deformed mesh. The attribute information may be encoded and decoded using a conventional video codec, such as HEVC, VVC, or AV1.

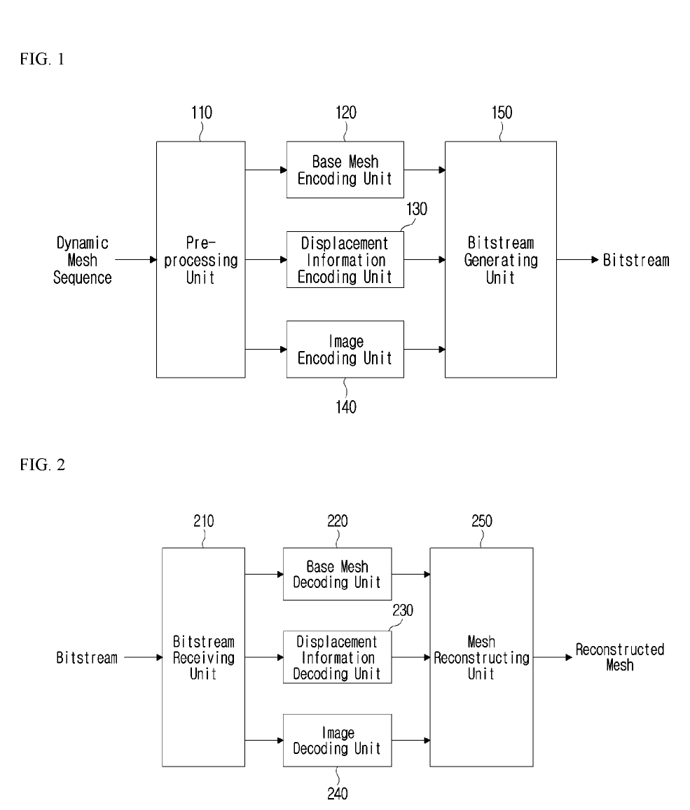

FIG. 1 is a block diagram of an encoder for encoding a dynamic mesh.

Referring to FIG. 1, the encoder may include a pre-processing unit 110, a base mesh encoding unit 120, a displacement information encoding unit 130, an image encoding unit 140, and a bitstream generating unit 150.

The pre-processing unit 110 separate geometric information of a dynamic mesh into base mesh and displacement information. To this end, the pre-processing unit 110 may perform at least one of mesh decimation, mesh parametrization, or mesh subdivision.

Mesh decimation refers to a process of reducing the number of vertices included in a mesh in order to decrease the amount of data to be encoded/decoded. Through the mesh decimation process, vertices with low importance are removed, and a base mesh may be generated. That is, the base mesh may have fewer vertices and faces than the original mesh. A vertex included in the base mesh may be referred to as a basic vertex.

Mesh parameterization refers to the process of providing coordinate system transformations for efficient mesh mapping and processing. Mesh parameterization facilitates the process of assigning attribute information to the shape and structure of a mesh.

As the number of vertices included in the mesh decreases, mesh restoration quality in the decoder more deteriorates. To reduce this problem, additional vertices may be generated by applying mesh subdivision technique to the base mesh. That is, mesh subdivision may represent to generate more vertices by subdividing polygons of the mesh. Through mesh subdivision, the resolution of the mesh is increased, and accordingly, a subdivided mesh with a more precise shape is obtained. A subdivided mesh may include an additional vertex generated through mesh subdivision in addition to basic vertices.

The pre-processing unit 110 may generate a 2D image by packing attribute information of each face included in the mesh into a 2D plane. Further, the pre-processing unit 110 may generate mapping information between a face packed in the 2D image and a face of the reconstructed mesh. Meanwhile, a group of attribute information packed in 2D image may be referred to as a patch.

The pre-processing unit 110 may generate displacement information for the subdivided mesh. The displacement information may include a displacement vector representing a difference between a position of a vertex in the subdivided mesh and a position of a corresponding vertex in a fitted mesh. The fitted mesh may be an approximated one to resemble the original mesh.

The base mesh encoding unit 120, the displacement information encoding unit 130, and the image encoder 140 each encode data generated through the pre-processing unit 110.

Specifically, the base mesh encoding unit 120 encodes the base mesh generated in the preprocessing unit 110.

Meanwhile, the base mesh may be encoded through an intra mode or an inter mode. When the inter mode is applied, a base mesh of a current frame may be derived based on a base mesh of a reference frame. Specifically, by compensating for motion of each vertex in the base mesh of the reference frame, the base mesh for the current frame may be derived.

When the base mesh is encoded in the inter mode, motion information may be encoded and signaled.

The displacement information encoding unit 130 encodes displacement information about vertices included in the subdivided mesh. Here, the displacement information is used to determine a position of a vertex in a 3D space and may include a displacement vector. The displacement vector represents a difference between a current position of a vertex in the subdivided mesh and a position of the corresponding vertex in the fitted mesh.

The image encoding unit 140 encodes attribute information. As an example, the image encoding unit 140 may encode a 2D image in which texture information (e.g., color information) of a mesh face (i.e., a surface of mesh) is packed.

The bitstream generating unit 150 multiplexes the encoded data and generates a bitstream.

Meanwhile, metadata may be generated and encoded so that a reverse process of a preprocessing process performed in the pre-processing unit 110 of the encoder may be performed. The bitstream may further include the metadata.

FIG. 2 is a block diagram of a decoder for decoding a dynamic mesh.

Referring to FIG. 2, the decoder may include a bitstream receiving unit 210, a base mesh decoding unit 220, a displacement information decoding unit 230, an image decoding unit 240, and a mesh reconstruction unit 250.

The bitstream receiving unit 210 demultiplexes the received bitstream and derives a plurality of pieces of encoded data. As an example, encoded attribute data, encoded base mesh data, and encoded displacement data may be derived through bitstream demultiplexing.

The base mesh decoding unit 220 decodes the encoded base mesh. Meanwhile, the base mesh may be decoded through the intra mode or the inter mode. When the inter mode is applied, the base mesh of the current frame may be derived based on the base mesh of the reference frame.

The displacement information decoding unit 230 decodes the encoded displacement information. The displacement information is used to determine a position of a vertex in the 3D space and may include a displacement vector.

The image decoding unit 240 decodes the attribute information. As an example, the image decoding unit 240 may decode a 2D image in which a plurality of patches is packed.

The mesh reconstruction unit 250 performs mesh subdivision on the decoded base mesh, adds the displacement information to the subdivided mesh, and reconstructs the geometric information of the mesh. In addition, the mesh reconstructing unit 250 may reconstruct the mesh by adding decoded attribute information to the mesh.

As described above, the encoder and decoder may perform subdivision on the base mesh using the same method. To perform subdivision on the base mesh at the decoder using the same method as the encoder, information related to the subdivision may be encoded and signaled.

The information related to the subdivision may include at least one of information indicating the number of subdivision iterations, information indicating whether the subdivision type is determined for each iteration, or information indicating the subdivision type for each iteration.

For example, the syntax "asve_subdivision_iteration_count," which indicates the number of subdivision iterations, may be encoded and signaled. The base mesh may be repeatedly subdivided the number of times indicated by "asve_subdivision_iteration_count."

If the number of subdivision iterations indicated by the syntax asve_subdivision_iteration_count is multiple, the syntax asve_lod_adaptive_subdivision_flag may be additionally encoded and signaled. The syntax asve_lod_adaptive_subdivision_flag may indicate whether the subdivision method is determined independently for each iteration. For example, a value of asve_lod_adaptive_subdivision_flag of 0 indicates that the same subdivision method is applied to all iterations. Conversely, a value of asve_lod_adaptive_subdivision_flag of 1 indicates that the subdivision method is determined independently for each iteration.

The syntax asve_subdivision_method[i] indicates the subdivision method for the i-th subdivision iteration. Here, the variable i may in a range from 0 to the value indicated by asve_subdivision_iteration_count, inclusive. The subdivision method indicated by the syntax asve_subdivision_method[i] may include at least one of midpoint subdivision, loop subdivision, normal subdivision, or Pythag subdivision. If the syntax asve_lod_adaptive_subdivision_flag is 0, the syntax asve_subdivision_method may be encoded/decoded only for the 0-th division iteration. Conversely, if the syntax asve_lod_adaptive_subdivision_flag is 1, the syntax asve_subdivision_method may be encoded/decoded for each subdivision iteration.

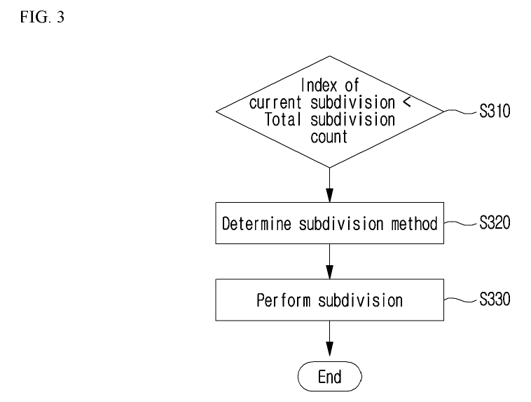

FIG. 3 is a flowchart of the process of subdividing a base mesh.

If the index of the current iteration is less than the total number of subdivision iterations S310, the subdivision method for the current iteration may be determined S320. If the current iteration is the first iteration, the subdivision method for the current iteration may be determined based on signaled information (e.g., asve_subdivision_method).

If the current iteration is not the first iteration, the subdivision method for the current iteration may be determined to be the same as the first iteration or determined based on signaled information indicating the subdivision method for the current iteration (e.g., asve_subdivision_method) according to whether the subdivision method for each iteration is determined independently.

Meanwhile, the subdivision method may be determined differently depending on the vertex type.

For example, if the vertex type represents 3D coordinates, the subdivision method may be determined based on the method described above. Conversely, if the vertex type represents 2D coordinates, the subdivision method may be adaptively determined based on the subdivision method for 3D coordinates. For example, if the subdivision method for 3D coordinates is a midpoint subdivision, a normal subdivision, or a Pythag subdivision, the subdivision method for 2D coordinates may be determined as a midpoint subdivision. Conversely, if the subdivision method for 3D coordinates is a loop subdivision, the subdivision method for 2D coordinates may be determined as a loop subdivision.

Based on the determined subdivision method, mesh subdivision may be performed S330.

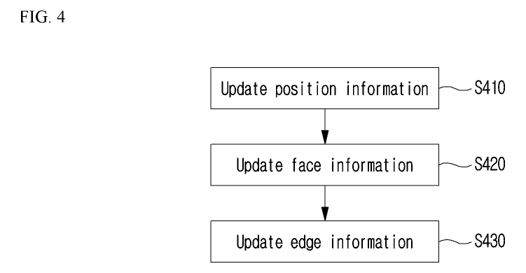

FIG. 4 is a flowchart illustrating the process of performing subdivision.

Referring to FIG. 4, subdivision may include updating position information S410, updating face information S420, updating edge information S430.

In updating the position information, the geometric position (i.e., coordinates) of a new vertex may be calculated using the position information of existing vertices. Furthermore, updating the position information may also include a process of recalculating the geometric position of an existing vertex according to the determined subdivision method.

Subsequently, through update of the face information update, the face information and connection information between the existing and newly generated vertices may be updated. Specifically, through subdivision, one face may be divided into four faces. Through update of the face information, the existing face is updated by a face with the newly generated vertices, and the remaining three faces may be further defined by combining the existing and new vertices. Through update of the face information, the indices of the vertices constituting each face may be (re)defined.

Furthermore, through update of the edge information, edge information and connection information between vertices may be updated for existing and newly generated vertices. Specifically, a single edge may be split into two edges through subdivision. Furthermore, through update of the face information, three additional edges may be generated within an existing face. The information of the vertices constituting each of these edges may be updated through update of the edge information. Through update of the edge information, the indices of the vertices constituting each edge may be (re)defined.

That is, through update of the face information and update of the edge information, connections between existing vertices may be broken, and connections between existing vertices and new vertices may be newly defined.

Meanwhile, adaptive edge segmentation may be performed, considering the characteristics of at least one of the edges or faces. For example, adaptive edge segmentation may not apply the same subdivision to all edges, but only apply subdivision to edges that satisfy certain conditions. If adaptive edge segmentation is performed, the face information update step and edge information update step of FIG. 4 may be changed to an adaptive face information update step and an adaptive edge information update step.

The adaptive update of face information may update face information by considering how many edges within a face have been subdivided. For example, if all three edges constituting a face are subdivided, the face may be divided into four faces. Conversely, if only two edges among three edges constituting a face are subdivided, the face may be divided into three faces. Conversely, if only one edge among three edges constituting a face is subdivided, the face may be divided into two faces. If no edges are subdivided, a face may be maintained without further segmentation.

The adaptive update of edge information, instead of updating information on all edges, updates information only for edges whose length is greater than a threshold. Additionally, in the adaptive update of face information, the configuration information of newly defined edges within the existing face is also updated to reflect the updated face information.

Adaptive edge segmentation may be limitedly used. For example, if the subdivision method in all subdivision iterations is midpoint subdivision, the adaptive edge segmentation may be applied only to the last subdivision iteration. Specifically, if the current iteration is not the last iteration, the face information update step and edge information update step of FIG. 4 are performed sequentially. However, if the current iteration is the last round, the adaptive face information update step and adaptive edge information update step 4 may be performed instead of the face information update step and edge information update step of FIG. 4.

When adaptive edge segmentation is applied, midpoint subdivision may be applied to an edge only if the edge length is greater than a threshold. That is, if the edge length is not greater than the threshold, the edge may not be subdivided.

Information related to adaptive edge segmentation may be encoded and signaled. For example, the syntax "asve_edge_based_subdivision_flag" may be encoded and signaled, indicating whether adaptive edge segmentation is applied. The syntax "asve_edge_based_subdivision_flag" of 1 indicates that adaptive edge segmentation is applied in the last subdivision iteration, if midpoint subdivision is applied to all subdivision iterations. Conversely, the synatx "asve_edge_based_subdivision_flag" of 0 indicates that adaptive edge segmentation is not applied.

When the syntax "asve_edge_based_subdivision_flag" is 1, the syntax "asve_subdivision_min_edge_length" may be encoded and signaled, indicating a threshold for adaptive edge segmentation. An edge may be subdivided only if its length is greater than the threshold indicated by the syntax "asve_subdivision_min_edge_length".

However, when adaptive edge segmentation is performed in a limited manner, the effectiveness of subdivision is reduced. For example, the requirement that all subdivision iterations should be midpoint subdivision and that adaptive edge segmentation be performed only for the last subdivision iteration results in a significantly reduced number of adaptive edge segmentation iterations, resulting in insufficient effectiveness of subdivision.

Furthermore, while adaptive edge segmentation effectively reduces the total number of output faces by determining whether to subdivide for each edge, it does not guarantee a reduction in the overall bitstream size. Furthermore, adaptive edge segmentation may also affects to a decrease in PSNR.

Therefore, the present disclosure proposes a method to enhance the effectiveness of adaptive edge segmentation.

### Embodiment 1

The number and types of subdivision methods to which adaptive edge segmentation is applied may be increased. Specifically, the four subdivision methods selectable via the syntax asve_subdivision_method are midpoint subdivision, loop subdivision, normal subdivision, and Pythag subdivision. As described above, instead of applying adaptive edge segmentation only when midpoint subdivision is selected, adaptive edge segmentation may also be applied even when other subdivision methods are selected.

For example, adaptive edge segmentation may be applied to all subdivision methods (i.e., all four subdivision methods). That is, the syntax asve_edge_based_subdivision_flag, which indicates whether adaptive edge segmentation is applied, may be encoded and signaled regardless of the subdivision method indicated by the syntax asve_subdivision_method.

The syntax indicating whether adaptive edge segmentation is applied may be encoded and signaled at a sequence level. Alternatively, a syntax indicating whether adaptive edge segmentation is applied may be encoded and signaled at a sub-unit level (e.g., a frame unit, a mesh patch unit, or a sub-mesh unit).

If adaptive edge segmentation is applied, a syntax indicating a threshold for adaptive edge segmentation (e.g., asve_edge_based_subdivision_flag) may be additionally encoded and signaled. This syntax may be encoded at the sequence level encoded and signaled at the sub-unit level

If the syntax indicates that adaptive edge segmentation is applied and the adaptive edge segmentation threshold is greater than 0, subdivision may be applied to the corresponding edge only if its length is greater than or equal to the threshold, regardless of the subdivision method.

Conversely, if adaptive edge segmentation is not applied or the adaptive edge segmentation threshold is 0, subdivision may be applied to all edges.

Instead of applying the same adaptive edge segmentation method to all subdivision methods, independent adaptive edge segmentation methods may be defined for each subdivision method. For example, adaptive edge segmentation methods may be separately defined for each of midpoint subdivision, loop subdivision, normal subdivision, and Pythag subdivision. Accordingly, the adaptive edge segmentation method may be set differently depending on the selected subdivision method.

After performing update of the position information according to the subdivision method, the adaptive edge segmentation method may be applied independently of the updated position information.

The adaptive edge segmentation method (i.e., the adaptive face information update step and the adaptive edge information update step) may be applied in the same manner for all subdivision methods, regardless of the selected subdivision method. That is, the subdivision method may be used only to calculate the geometric positions (i.e., coordinates) of existing and newly generated vertices, and not to update face or edge information. Regardless of the subdivision method, the face information update step and the edge information update step are performed in the same manner. Therefore, the update results obtained through the face information update step and the edge information update step may be identical between the subdivision methods.

As another example, after performing update of the position information according to the subdivision method, an adaptive edge segmentation method may be applied depending on the updated position information. To simplify operations, the adaptive edge segmentation method (i.e., the adaptive face information update step and the adaptive edge information update step) may be performed based on the position information updated according to the predefined subdivision method. Here, the predefined subdivision method may be a midpoint subdivision method. That is, regardless of the selected subdivision method, the adaptive edge segmentation method may be performed by utilizing updated position information based on a predefined subdivision method.

When applying the adaptive edge segmentation method independently of updated position information or when applying the adaptive edge segmentation method based on updated position information based on a predefined subdivision method, the adaptive edge segmentation method (i.e., the adaptive face information update step and the adaptive edge information update step) is applied in the same manner for all subdivision methods, regardless of the selected subdivision method. Accordingly, the adaptive edge segmentation method should not be controlled by the subdivision method itself, but only be controlled by at least one of information indicating whether to perform adaptive edge segmentation, a threshold for adaptive edge segmentation, or the number of subdivision iterations.

As another example, an adaptive edge segmentation method may be defined separately for each subdivision method, and the adaptive edge segmentation method corresponding to the selected subdivision method may be applied.

For example, the adaptive face update step and the adaptive edge update step may be performed with reference to the position information updated by the selected subdivision method.

Alternatively, an optimized adaptive face update step and an adaptive edge update step may be defined separately for each subdivision method. For example, depending on the selected subdivision method, one of edge length-based midpoint subdivision, edge length-based loop subdivision, edge length-based normal subdivision, or edge length-based Phthag subdivision may be performed.

For adaptive edge segmentation, operation information for the subdivision method may be provided. For example, information obtained in the position information update step may be input for adaptive edge segmentation.

For example, if the subdivision method is loop subdivision, at least one of the adjacent vertex index information or adjacent vertex weight information obtained for each vertex through the position information update step may be input to the adaptive edge segmentation process. Alternatively, if the subdivision method is normal partial discounting, newly added refinement vector information for each vertex obtained through the position information update step may be input to the adaptive edge segmentation process. The refinement vector information may include at least one of whether the refinement is performed or not or the refinement vector.

Alternatively, if the subdivision method is Phthag subdivision, at least one of the index information of adjacent vertex, the weight information of adjacent vertex, or the Pythagorean mean type obtained for each newly added vertex through the position information update step may be input to the adaptive edge segmentation process. Here, the Pythagorean mean type may represent at least one of the arithmetic mean, the geometric mean, or the harmonic mean.

That is, depending on the selected subdivision method, at least one of the index information of adjacent vertex, the weight information of adjacent vertex, or the refinement vector information may be used for adaptive edge segmentation. That is, the enumerated elements may be input to the adaptive face update step and the adaptive edge update step.

### Embodiment 2

Adaptive edge segmentation may be applied to all subdivision iterations. To achieve this, information indicating whether adaptive edge segmentation is applied to all subdivision iterations may be encoded and signaled. For example, if the flag indicating whether adaptive edge segmentation is performed is true and the threshold for adaptive edge segmentation is greater than 0, adaptive edge segmentation may be applied to all subdivision iterations. Conversely, if the flag indicating whether adaptive edge segmentation is performed is false or the threshold for adaptive edge segmentation is 0, adaptive edge segmentation may not be applied to any subdivision iterations.

Alternatively, whether to apply adaptive edge segmentation may be determined individually for each subdivision iteration.

For example, adaptive edge segmentation may be applied only to a specific subdivision iteration, based on a user configuration.

Alternatively, adaptive edge segmentation may be applied only to a specific subdivision iteration pre-defined in the encoding system. Alternatively, the encoder or decoder may derive an optimal subdivision iteration to which adaptive edge segmentation can be applied. Adaptive edge segmentation may then be applied only to the derived subdivision iteration.

Alternatively, information for performing adaptive edge segmentation may be explicitly encoded and signaled for each subdivision iteration or each Level of Detail (LoD). The information for performing adaptive edge segmentation may include at least one of a flag indicating whether to perform adaptive edge segmentation or a syntax indicating a threshold for adaptive edge segmentation. That is, the information for performing adaptive edge segmentation may be encoded and signaled as many times as the number of subdivision iterations or the number of LoDs. Alternatively, the decoder may implicitly derive information for performing adaptive edge segmentation in the same manner as the encoder.

Information indicating whether adaptive edge segmentation is to be applied uniformly to all subdivision iterations or individually determined for each subdivision iteration may be encoded and signaled. For example, a syntax LoD-based_adaptive_edge_sementation_flag indicating whether adaptive edge segmentation is to be applied to all subdivision iterations may be encoded and signaled. If the flag is false, adaptive edge segmentation may be applied to all subdivision iterations, or adaptive edge segmentation may not be applied to any of subdivision iterations.

On the other hand, when the flag is true, whether adaptive edge segmentation is to be applied may be determined independently for each subdivision. For example, if the flag is true, information indicating whether adaptive edge segmentation is to be applied may be encoded and signaled for each subdivision iteration. When adaptive edge segmentation is applied, information indicating the threshold for adaptive edge segmentation may be additionally encoded and signaled.

Information indicating whether adaptive edge segmentation should be applied to all subdivision iterations may be encoded and signaled at the sequence or sub-mesh level.

### Embodiment 3

When adaptive edge segmentation is applied, the edge segmentation depth (Edge Segmentation Depth) can be determined in units of edges. Here, the edge segmentation depth may indicate the number of hierarchies (i.e., the number of recursive segmentations) when edge segmentation is performed hierarchically or recursively.

For example, an edge segmentation depth of 3 for a specific edge indicates that edge segmentation is performed three times for that edge. Accordingly, the edge may be segmented into eight (2³) edges.

The edge segmentation depth may be determined for each edge. For example, the edge segmentation depth may be set to 3 for the first edge, while the edge segmentation depth may be set to 0 for the second edge. Consequently, the first edge may be segmented three times, while the second edge may not be segmented.

That is, rather than determining whether to apply adaptive edge segmentation for each subdivision iteration or repeating adaptive edge segmentation for the number of subdivision iterations, the number of edge segmentation iterations may be determined for each edge.

Determining the edge segmentation depth for each edge may have a similar effect as determining the number of subdivision iterations for each edge.

The edge segmentation depth may be determined for each edge based on edge characteristics. For example, the edge segmentation depth may be determined based on the length of the edge.

Alternatively, edge segmentation may be repeated recursively until the segmented edge length falls below a threshold.

Alternatively, information for determining the edge segmentation depth may be encoded and signaled. For example, information regarding at least one of the edge segmentation depth, minimum edge segmentation depth, or maximum edge segmentation depth may be encoded and signaled. The information may be encoded and signaled in units of sequences, frames, meshes or edges.

Alternatively, information indicating the edge segmentation depth may be encoded and signaled for each edge, while information indicating at least one of the minimum edge segmentation depth or the maximum edge segmentation depth may be encoded and signaled for each sequence or sub-mesh. Edges referring to a sequence or sub-mesh header may refer to at least one of the minimum edge segmentation depth or the maximum edge segmentation depth signaled through the sequence or sub-mesh header.

Alternatively, information indicating the edge segmentation depth may be implicitly inferred by the decoder using the same rule-based algorithm as the encoder.

Alternatively, when adaptive edge segmentation is applied, a face segmentation tree structure may be determined for each face. The face segmentation tree structure may be defined based on at least one of the face segmentation tree type or the face segmentation tree depth. The face segmentation tree type may include at least one of a binary tree, a ternary tree (triple tree), or a quad tree.

The face segmentation tree depth may indicate the number of hierarchies in which face segmentation is performed (i.e., the number of recursive segmentations) when face segmentation is performed hierarchically or recursively.

The face segmentation tree structure may be determined for each face. Specifically, the face segmentation tree structure may be determined based on the characteristics of the edges constituting the face.

For example, the face segmentation tree structure may be determined based on the face shape.

Alternatively, the face segmentation tree structure may be determined based on the edge length constituting the face.

Alternatively, information for determining the face segmentation tree structure may be encoded and signaled. For example, information regarding at least one of the face segmentation tree type, the face segmentation tree depth, the minimum face segmentation tree depth, and the maximum face segmentation tree depth may be encoded and signaled. The information may be encoded and signaled in units of faces.

Alternatively, information regarding at least one of the face segmentation tree type or face segmentation tree depth may be encoded and signaled in units of faces, while information indicating at least one of the minimum face segmentation depth or the maximum face segmentation depth may be encoded and signaled in units of sequences or sub-meshes. Faces referring to a sequence or sub-mesh header may refer to at least one of the minimum face segmentation depth or the maximum face segmentation depth signaled through the sequence or sub-mesh header.

Alternatively, information regarding at least one of the face segmentation tree type or face segmentation tree depth may be implicitly inferred by the decoder using the same rule-based algorithm as the encoder.

### Embodiment 4

When adaptive edge partitioning is applied, the number of newly generated vertices may be determined adaptively. For example, conventionally, when subdivision is performed on an edge, the number of newly generated vertices is 1. When subdivision is not performed on an edge, the number of newly generated vertices is 0. In contrast, according to the embodiment proposed in the present disclosure, two or more new vertices may be generated through adaptive edge segmentation.

That is, the number of newly generated vertices, N, through adaptive edge segmentation is an integer greater than or equal to 0, and may be set to any integer greater than 1, as well as 0 and 1.

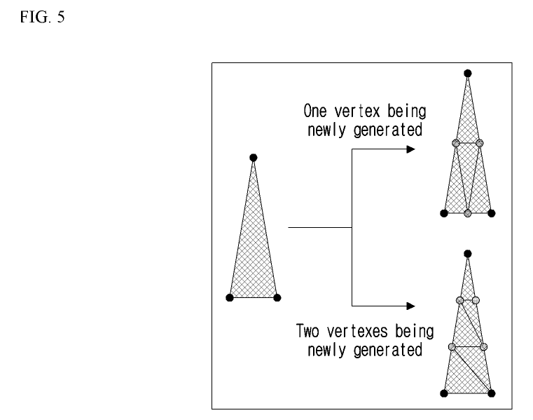

FIG. 5 illustrates cases where the number of newly generated vertices is 1 and 2 through edge segmentation.

Information indicating the maximum or minimum number of vertices that can be generated through adaptive edge segmentation may be encoded and signaled. Alternatively, the number of newly generated vertices may be adaptively determined in units of edge or in units of faces. For example, the number of vertices that may be generated from edges constituting a face may be determined based on at least one of the face shape and the face size.

Based on the number of newly generated vertices, the adaptive face update step and the adaptive edge update step may be performed. For example, the methods of the adaptive face update step and the edge update step may differ depending on whether one new vertex is generated per edge or two new vertices are generated per edge.

### Embodiment 5

As described above, whether to subdivide an edge may be determined by comparing the length of the edge to a threshold. For example, if the edge length is greater than the threshold, subdivision may be performed on the edge. If the edge length is equal to or less than the threshold, subdivision may not be performed on the edge.

As another example, subdividing may be determined based on other geometric characteristics, not just edge length. Specifically, a condition for adaptive edge segmentation may be defined for each mesh component, such as an edge, face, or vertex.

For example, whether to subdivide an edge may be determined only for an edge that satisfy the edge-based subdivision condition. For example, subdivision may be applied only if the edge length is greater than the threshold. When using edge length as a condition, a single threshold may be applied to all edges.

Alternatively, a threshold may be determined in units of edges. For example, a threshold for edge subdivision may be adaptively determined based on local spatial characteristics. By adaptively determining the threshold based on local spatial characteristics, the frequency of edge-length-based subdivision may be controlled. In other words, edge-length-based subdivision may be performed non-uniformly across regions, depending on local spatial characteristics.

Alternatively, a threshold for edge-length-based subdivision may be adaptively determined for each coding unit. The coding unit may include sub-meshes, etc. To this end, information indicating a threshold value may be encoded and signaled for each coding unit.

Alternatively, a threshold value may be determined for each subdivision iteration. To this end, information indicating a threshold value may be encoded and signaled for each subdivision iteration.

Subdivision or determination of the segmentation structure may be performed only to a face that satisfy a face-based condition or edges belonging to the face.

For example, one of multiple partitioning structures may be selected based on the face shape.

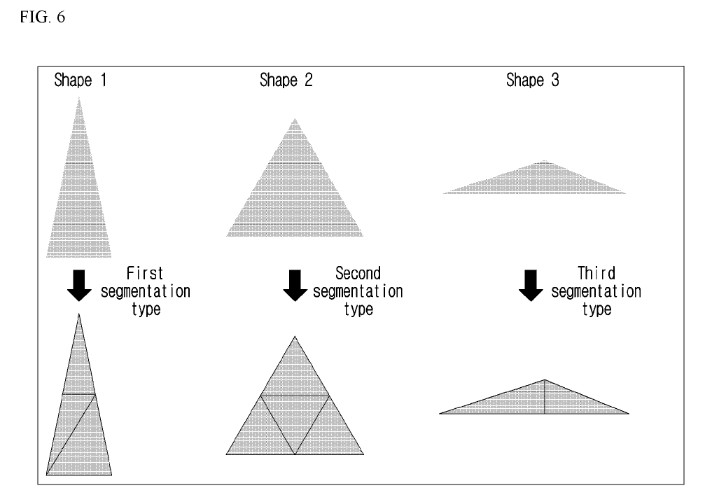

FIG. 6 illustrates an example in which the partitioning structure is determined differently depending on the face shape.

Depending on the partitioning structure, the number of faces generated through the subdivision may be different.

Meanwhile, subdivision may be performed on a face only if the size (i.e., area) of the face is greater than a threshold.

The conditions for determining whether to apply subdivision may be preconfigured or preselected by the user. Alternatively, the encoder may adaptively determine the conditions for determining whether to apply subdivision.

Alternatively, information indicating whether to use at least one of the multiple conditions for determining whether to apply subdivision may be encoded and signaled.

### Embodiment 6

Adaptive edge segmentation may be controlled based on the face ratio. Here, the face ratio may be calculated based on at least one of the number of faces in the input mesh, the number of faces in the subdivided mesh, the number of faces in the decoded mesh, or the number of faces in the base mesh.

The number of faces in the subdivided mesh or the number of faces in the decoded mesh may be varied, depending on whether edge segmentation is applied. For example, the number of faces in the decoded mesh with edge segmentation applied and the number of faces in the decoded mesh without edge segmentation may be present.

For example, the face ratio may represent the rate of change in the number of faces between the input mesh and the output mesh, or the rate of change in the number of faces before and after mesh subdividing. Here, the rate of change may represent the rate of increase or decrease in the number of faces.

For example, the face ratio may represent the ratio between the number of faces constituting the input mesh and the number of target faces in the decoded mesh.

Alternatively, the face ratio may represent the ratio between the number of target faces in the decoded mesh without application of edge segmentation and the number of target faces in the decoded mesh with application of edge segmentation.

Alternatively, the face ratio may represent the ratio between the number of faces constituting the base mesh and the number of target faces in the decoded mesh.

Instead of the face ratio, the edge ratio or vertex ratio may be used to control adaptive edge segmentation.

To determine the adaptive edge segmentation ratio regardless of the geometry of the input mesh, the face reduction ratio may be used. Specifically, based on a predefined face reduction ratio, the encoder may calculate a threshold for optimal edge length-based subdivision and encode and signal a syntax indicating the determined threshold to the decoder.

The encoder may determine the threshold by referring to the face reduction ratio and edge length distribution information. The edge length distribution may be derived using at least one of the edge length distribution of the input mesh, the edge length distribution of the base mesh, the edge length distribution of the subdivided mesh, or the edge length distribution of the encoded mesh.

Information indicating the face reduction ratio may be encoded and signaled to the decoder. The decoder may determine a threshold based on the face reduction ratio and the edge length distribution (e.g., the edge length distribution of the decoded base mesh or the edge length distribution of the subdivided mesh) in the same manner as the encoder.

Alternatively, the threshold value may be adaptively determined based on the edge length statistics. Here, the edge length statistics may include at least one of an average, a variance, a standard deviation, or median of the edge lengths.

Once the threshold is determined, the edge length may be compared to the threshold to determine whether to perform subdivision on the edge.

The face reduction ratio in an inter-coded frame (i.e., a P or B frame) may be determined by referencing the face reduction ratio in a decoded intra-coded frame (i.e., an I frame).

Alternatively, the threshold, determined based on the face reduction ratio in an I frame, may also be applied to a P or B frame.

### Embodiment 7

Whether to apply adaptive edge segmentation may be determined for each coding unit. Here, the coding unit may be a sub-mesh.

For example, the subdivision method and whether to apply adaptive edge segmentation may be determined for each coding unit. Accordingly, the subdivision method or whether to apply adaptive edge segmentation may be set differently for each coding unit.

Information for adaptive edge segmentation may be encoded and signaled for each coding unit. For example, at least one of a syntax indicating whether adaptive edge segmentation is applied and a syntax indicating a threshold for adaptive edge segmentation may be encoded and signaled in units of sub-meshes.

Alternatively, information for adaptive edge segmentation for each coding unit may be adaptively determined by considering geometric characteristics. Here, the geometric characteristics may include at least one of the number of faces, the number of vertices, the average size of faces, the vertex density, or the average length of edges. For example, a threshold for adaptive edge segmentation may be calculated or the determined threshold may be adjusted based on the number of faces or vertices that constitute the current sub-mesh.

Adaptive edge segmentation may not to be applied to a components determined as an outlier (e.g., an outlier face, an outlier edge, or an outlier vertex).

For example, even when adaptive edge segmentation is enabled, adaptive edge segmentation may not be applied to a component determined as an outlier. Here, not applying adaptive edge segmentation may represent applying subdivision to an edge without comparing the edge length to a threshold, or may represent not applying subdivision to an edge.

The above-described embodiments relate to mesh subdivision in dynamic mesh encoding/decoding processes. However, the embodiments proposed in the present disclosure are not necessarily applicable to mesh encoding/decoding processes. The embodiments proposed in the present disclosure may also be applied to data segmentation processes in volumetric media processing.

Here, volumetric media may refer to multidimensional realistic media, such as a mesh, a point cloud, a voxel, or Gaussian splat. Furthermore, the volumetric media processing process may include volumetric media encoding/decoding or conversion of a volumetric media resolution. Furthermore, the data segmentation process may refer to a process of converting low-resolution data into high-resolution data, such as mesh subdivision.

According to the present disclosure, encoding/decoding efficiency may be improved through adaptive mesh segmentation.

According to the present disclosure, encoding/decoding efficiency may be improved by determining whether to perform adaptive mesh segmentation in units of coding units of subdivision iterations.

According to the present disclosure, encoding/decoding efficiency may be improved by performing adaptive mesh segmentation based on characteristics of faces, edges, of vertices.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of encoding a dynamic mesh, comprising:
obtaining a base mesh from an input mesh;
generating a subdivided mesh by subdividing the base mesh;
generating displacement information based on the subdivided mesh; and
encoding the base mesh and the displacement information,
wherein the method further comprises determining whether adaptive edge segmentation is applied to at least one of subdivision iterations.

2. The method of claim 1, wherein in response to the adaptive edge segmentation being applied, whether to subdivide an edge is determined by comparing a length of the edge with a threshold value.

3. The method of claim 2, wherein in response to the edge being subdivided, a number of newly generated vertices subdividing the edge is greater than or equal to 1.

4. The method of claim 2, wherein the threshold value is determined in a unit of sub-mesh.

5. The method of claim 2, wherein the threshold value is determined in a unit of subdivision iteration.

6. The method of claim 2, wherein the threshold value is adaptively determined based on at least one of a ratio of vertex, a ratio of face, a number of vertices, or a number of faces.

7. The method of claim 2, wherein the threshold value is adaptively determined based on a statice of edge lengths.

8. The method of claim 1, wherein the adaptive edge segmentation is enabled not only when a subdivision method is a midpoint subdivision, but also when the subdivision method is a loop subdivision, a normal subdivision, or Pythag subdivision.

9. The method of claim 8, wherein in response to the adaptive edge segmentation being applied, face information and edge information are updated based on position information updated based on a pre-defined subdivision method.

10. The method of claim 9, wherein the pre-defined subdivision method is the midpoint subdivision.

11. The method of claim 8, wherein in response to the adaptive edge segmentation being applied, face information and edge information are updated based on position information updated based on a subdivision method determined by signaled information.

12. The method of claim 11, wherein the subdivision method determined by the signaled information is one of the midpoint subdivision, the loop subdivision, the normal subdivision, or the Pythag subdivision.

13. The method of claim 1, wherein whether the adaptive edge segmentation is applied or not is determined for each of subdivision iteration.

14. The method of claim 1, wherein in response to the adaptive edge segmentation being applied, a segmentation depth is determined in a unit of edge.

15. The method of claim 1, wherein in response to the adaptive edge segmentation being applied, at least one of a segmentation tree type or a segmentation depth is determined in a unit of face.

16. The method of claim 1, wherein in response to the adaptive edge segmentation being applied, one of segmentation structures is selected according to a shape of a face.

17. The method of claim 2, wherein even though the adaptive edge segmentation is applied, subdivision on a face, an edge or a vertex that is determined as an outlier is performed without comparing the length of the edge with the threshold value.

18. A method of decoding a dynamic mesh, comprising:
decoding a base mesh;
generating a subdivided mesh by subdividing the base mesh; and
reconstructing a mesh based on the subdivided mesh and decoded displacement information,
wherein the method further comprises determining whether adaptive edge segmentation is applied to at least one of subdivision iterations.

19. A non-transitory computer-readable medium storing instructions that, when executed, cause a computer to carry out:
obtaining a base mesh from an input mesh;
generating a subdivided mesh by subdividing the base mesh;
generating displacement information based on the subdivided mesh; and
encoding the base mesh and the displacement information,
wherein the method further comprises determining whether adaptive edge segmentation is applied to at least one of subdivision iterations.
